(19) United States
(12) Patent Application Publication
(10) Pub. No.: US 2008/0316165 A1
(43) Pub. Date: Dec. 25, 2008

(54) LIQUID CRYSTAL DISPLAY HAVING INVERTER FOR CONTROLLING BACK LIGHT FOR LIQUID CRYSTAL DISPLAY PANEL HAVING A VARIETY OF SHAPES TO OBTAIN UNIFORM LUMINANCE

(75) Inventors: Yong Beom KIM, Bupyeong-Gu (KR); Woon Yong Park, Paldal-Gu (KR); Kyu Yeol Kim, Wonmi-Gu (KR)

Correspondence Address: YONG BEOM KIM;GA-KYUNG INTERNATIONAL PATENT & LAW OFFICE, 4TH FLOOR YEUNSU BLDG., 1149 GUWEOL-1 DONG, NAMDONG-GU, INCHEON, KR

(73) Assignee: TOVIS Co., Ltd., Wonju-City (KR)

(21) Appl. No.: 11/765,708

(22) Filed: Jun. 20, 2007

(51) Int. Cl. G09G 3/36

(52) U.S. Cl. 345/102

(57) ABSTRACT

There is provided a liquid crystal display. The liquid crystal display includes a TFT-LCD panel having any one of a variety of shapes including a circular shape, an elliptical shape, a circular arc shape, and a shape with an angle other than 90°; a plurality of straight light sources disposed at a rear side of the TFT-LCD panel and having a different length according to the shape of the TFT-LCD panel; and an inverter and a transformer connected to one terminal of each light source, wherein the inverter induces a same current to the light sources having a different length and the transformer supplies a boosted voltage lo dependent on the length of each light source to the light source so that luminance is uniform. With the straight light sources having a different length for a back light unit suitable for a liquid crystal display panel having a variety of shapes including circular, elliptical, fan, and semicircular shapes according to the present invention, image quality of uniform luminance can be implemented on the entire display area of the panel.

### BACKGROUND OF THE INVENTION

1. Technical Field

The present invention relates to a liquid crystal display having an inverter for controlling a back light for a liquid crystal display panel having a variety of shapes including circular, elliptical, and semicircular shapes to obtain uniform luminance, in which light from straight light sources having a different length of the back light is transmitted by the liquid crystal display panel so that image quality of uniform luminance is implemented.

2. Discussion of Related Art

In general, a liquid crystal display (LCD) converts electrical information from an apparatus into visual information using a change in the permittivity of liquid crystal dependent on an applied voltage. Since the liquid crystal display itself cannot emit light required forming an image, it comprises a back light unit. The liquid crystal display forms an image using light emitted from the back light unit.

The back light is generally required to maintain high and uniform luminance and consume less power. The back light is controlled by an inverter, which converts a low DC voltage into an AC voltage and converts the AC voltage into a higher AC voltage using a transformer to operate a lamp.

FIG. 1 is a schematic diagram illustrating a conventional backlight inverter for a straight lamp.

The conventional backlight inverter 10 for a straight lamp comprises a transformer driving unit 11 for converting an input DC voltage into an AC voltage in response to a control signal, a transformer 12 for boosting the AC voltage from the transformer driving unit 11 to a higher voltage on the order of 1 to 2 KV required for operating a lamp, and providing the voltage to the lamp, a current detecting unit 13 for detecting current Is flowing through the lamp, and a control unit 14 for determining whether an output stage of the backlight inverter is lo opened or short-circuited based on the detected current from the current detecting unit 13 and controlling the shutdown of the driving unit 11.

The current detecting unit 13 comprises a resistor R connected to a cold terminal of the lamp. The current detecting unit 13 detects a voltage corresponding to a current flowing through the resistor. The operation of the conventional backlight inverter will be described. When the lamp is normally connected, it normally is turned on, the detected voltage and current are applied to the control unit 15, and the output of the backlight inverter is kept constant.

The operation when a hot terminal and the cold terminal of the lamp are opened and short-circuited, i.e., when the inverter is in an abnormal state will be described. First, when the output stage of the backlight inverter is opened, current does not flow the lamp and the detected current Is becomes “0”. Accordingly, the control unit shuts the inverter down. When the output stage of the backlight inverter is short-circuited to a ground, i.e., when the output stage of the backlight inverter is connected to the ground, the detected current Is becomes “0” and the control unit shuts the inverter down.

In the conventional backlight inverter for a straight lamp, when the hot and cold terminals of the lamp is opened or short-circuited, the detected current Is becomes “0” and the backlight inverter is shut down.

In recent years, a technique of using a U-figured lamp as a back light has been studied and developed since the U-figured lamp is superior in efficiency to a straight lamp.

One example is disclosed in Korean Patent No. 616613 entitled 10 “Backlight inverter for U-figured Lamp”, in which the inverter can be shut down when it is abnormal, and reliability of operation can be improved.

In the conventional technique, even though light sources for a straight back light unit have a straight shape or a U-figured shape, a liquid crystal display panel comprising such light sources mainly is a rectangular TFT-LCD panel. Accordingly, lamps connected to a plurality of inverters should have the same length and the same voltage is supplied to the lamps.

Meanwhile, in Korean Patent Application No. 2005-102495 filed by the same applicant and entitled “Display Device Having A Variety Of Shapes And Game Machine Having The Same”, and Korean Patent Application No. 2007-19848 entitled “Thin Film Transistor Liquid Crystal Display Panel Having A Variety Of Shapes and Method For Manufacturing The Same”, a TFT-LCD panel has a non-rectangular shape.

In the rectangular TFT-LCD panel, straight lamps for a back light unit always have the same length. On the other hand, in a TFT-LCD panel having a variety of shapes filed by the same applicant, straight lamps for a back light unit may have a different length.

As the lamps having a different length are controlled by the inverter, luminance gets nonuniform and precise image quality is not obtained.

### SUMMARY OF THE INVENTION

An aspect of the present invention provides a liquid crystal display in which a straight light source for a back light unit applied to a TFT-LCD panel having a variety of shapes including elliptical, semicircular, and circular shapes is implemented by at least one of a U-figured lamp, a straight lamp, and a lamp having a length and shape dependent on the shape of the TFT-LCD panel, so that image quality of uniform luminance is implemented.

Exemplary embodiments of the present invention provide an inverter having transformers having a different boosting condition, so that uniform luminance is obtained by light sources having a different length for a back light unit which is applied to a TFT-LCD panel having a variety of shapes.

Other embodiments of the present invention provide a liquid crystal display having an inverter for controlling a back light for a liquid crystal display panel having a variety of shapes to obtain uniform luminance, the liquid crystal display comprising:

a TFT-LCD panel having any one of a variety of shapes including a circular shape, an elliptical shape, a circular arc shape, and a shape with an angle other than 90°;

a plurality of straight light sources disposed at a rear side of the TFT-LCD panel and having a different length dependent on the shape of the TFT-LCD panel; and

an inverter and a transformer connected to one terminal of each light source, wherein the inverter induces a same current to the light sources having a different length and the transformer supplies a boosted voltage dependent on the length of each light source to the light source so that luminance is uniform.

The light sources may have U-figured lamps, straight lamps, or lamps having a length and shape dependent on the shape of the TFT-LCD panel. The light sources having the same length may be connected to one inverter and one transformer. All the light sources may be connected to one inverter and transformers, and the transformers are arranged sequentially in such a manner that a first transformer is connected to the light source having the smallest length and a last transformer is connected to the light source having the greatest length.

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic diagram illustrating a conventional backlight inverter for a straight lamp;

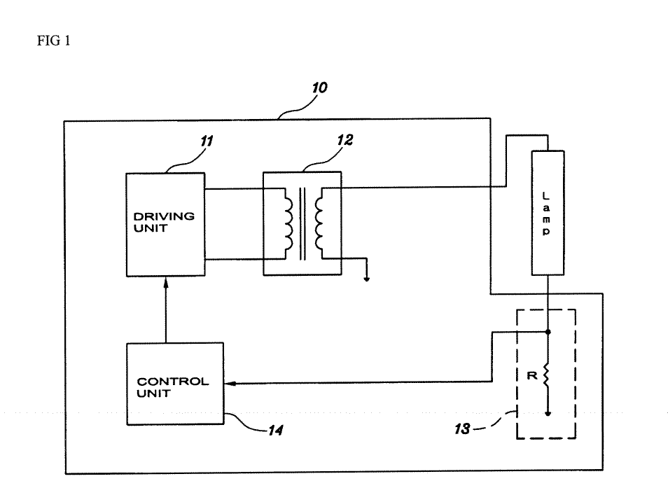

FIG. 2 is an exploded perspective view illustrating a straight back light unit for a TFT-LCD panel having a semicircular shape according to the present invention;

FIG. 3 is an exploded perspective view illustrating a straight back light unit of a TFT-LCD panel having a circular shape, unlike FIG. 2;

FIG. 4 is a schematic diagram illustrating an arrangement of light sources and inverters for controlling the light sources in a TFT-LCD panel having a semicircular shape according to an embodiment of the present invention;

FIG. 5 is a schematic diagram illustrating light sources having the same length controlled by the same inverter and transformer in the TFT-LCD panel having the semicircular shape;

FIG. 6 is a schematic diagram illustrating light sources controlled by one inverter comprising transformers corresponding in number to light sources in a TFT-LCD panel having a fan shape according to an embodiment of the present invention; and

FIG. 7 is a schematic diagram illustrating an arrangement of inverters and transformers for controlling light sources in a TFT-LCD panel having a semicircular shape according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention. Like numbers refer to like element.

As shown in the drawings, the present invention provides a liquid crystal display having an inverter for controlling a back light to obtain uniform luminance, in which light sources having a different length for the straight back light are controlled by the same rated voltage, so that an image of uniform luminance is implemented on a TFT-LCD panel having a variety of shapes by the light sources.

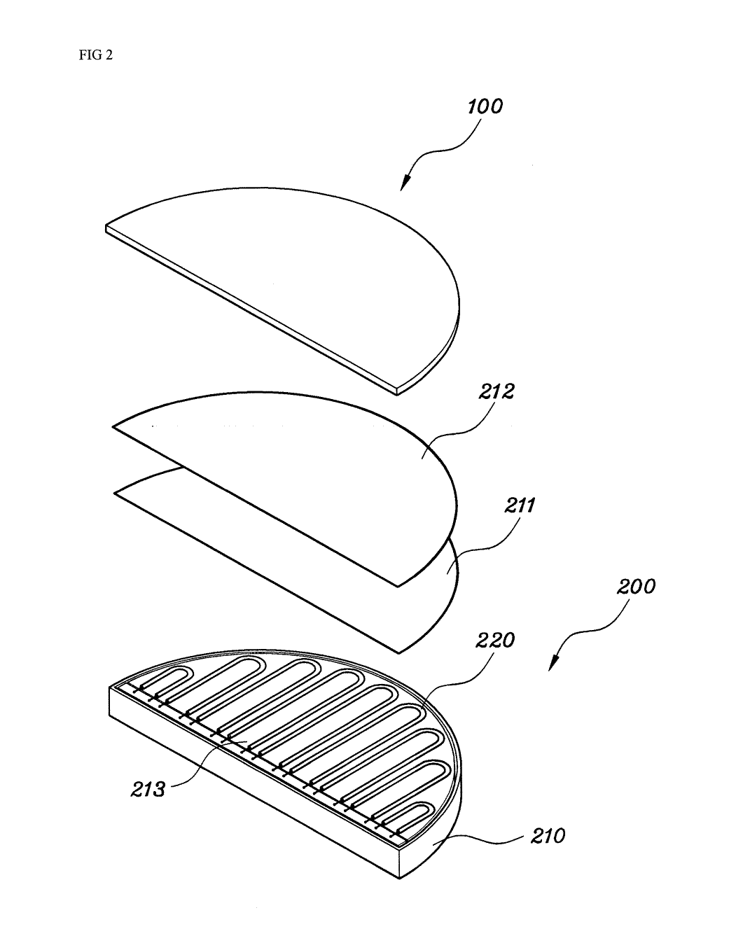

As shown in FIG. 2, the present invention provides a back light unit 200 disposed at a rear side of a TFT-LCD panel 100 having at least one of a variety of shapes including a circular, elliptical, semicircular, and circular arc shapes.

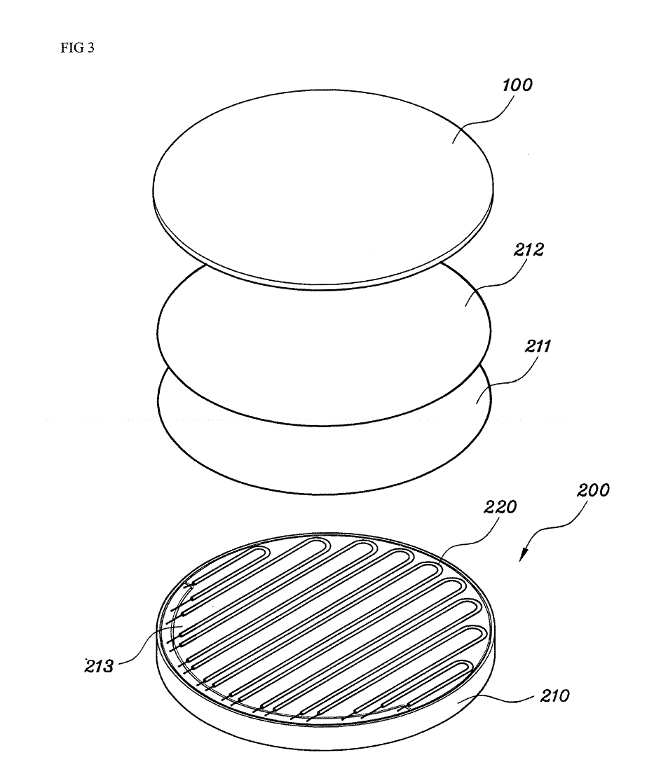

The TFT-LCD panel 100 has the semicircular or circular shape as shown in FIGS. 2 and 3, but the present invention are not limited thereto.

The back light unit 200 has the same shape as the TFT-LCD panel 100, as described above. It will be easily appreciated that a frame 210 may also have the same shape as the TFT-LCD panel 100.

Light sources 220 are disposed in the frame 210 of the back light unit 200 that may have a variety of shapes, and a diffuser sheet 211 is disposed over the frame 210.

A reference numeral 212 denotes a prism sheet and 213 denotes a reflector sheet.

The light sources 220 as lamps are arranged in a straight form inside the frame 210 depending on, for example, the width of the TFT-LCD panel 100.

As shown in FIGS. 2 and 3, the light sources 220, i.e., the lamps have a different length. In the present invention, the light sources 220 may have U-figured lamps, straight lamps, or lamps having a length and shape dependent on the shape of the TFT-LCD panel 100.

When the TFT-LCD panel 100 has a semicircular shape or a circular or elliptical shape as shown in FIGS. 2 and 3, the light sources 220 having a relatively shorter length are disposed at the left and right.

An inverter 230 converts a DC voltage to an AC voltage in response to a control signal, and a transformer 240 boosts the AC voltage and supplies the boosted voltage to the light sources 220 having a different length. When the same boosted AC voltages are supplied to the light sources 220, luminance and image quality implemented on the TFT-LCD panel 100 become nonuniform due to the different lengths of the light sources.

To solve this problem, it is necessary to supply different voltages between the relatively longer light sources 220 and the relatively shorter light sources 220.

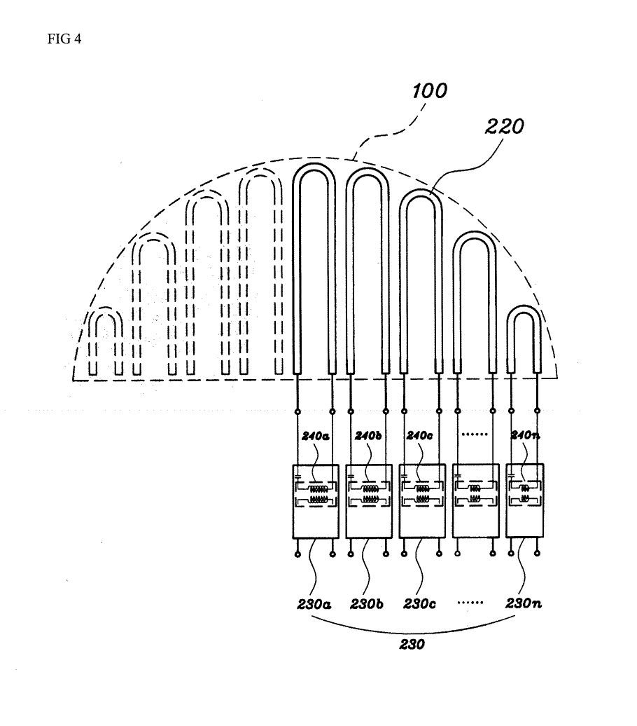

To this end, a plurality of inverters 230 connecting between the light sources 220 having the same length are arranged for providing voltages boosted to suitable voltages by the transformer 240, to the light sources 220, as shown in FIGS. 4 to 6. The voltages boosted by the transformer 240 depend on the lengths of the light sources 220.

As shown in FIG. 4, the inverters 230, 230a to 230n including transformers 240, 240a to 240n are connected to the light sources 220 having a different length. The transformers 240, 240a to 240n have a different boosting condition. The boosted voltages having a different size are supplied to the light sources 220. Accordingly, even though the light sources 220 have the different length, the luminance becomes uniform and the same image quality can be implemented over an entire display area of the TFT-LCD panel 100 having a variety of shapes.

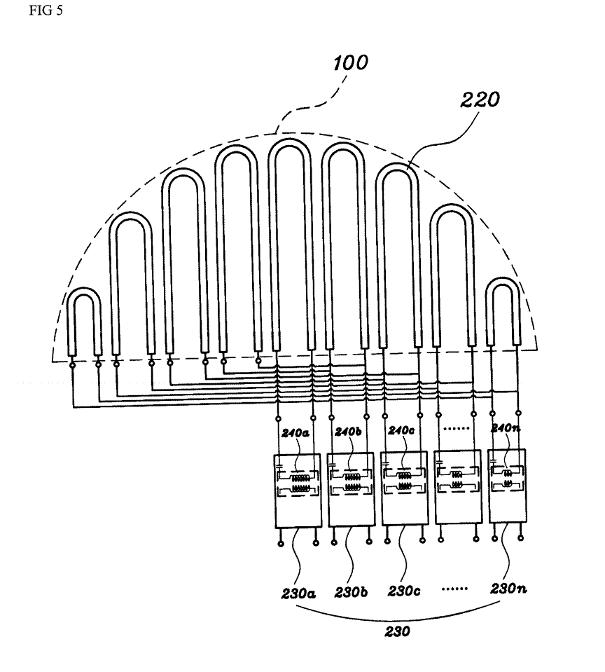

In FIG. 5, among the light sources 220, the light sources 220 having the same length are connected with inverters 230 having transformers 240 that have the same boosting condition, i.e., that can supply the same boosted voltage so that the luminance is uniform.

According to the embodiment of FIG. 5, the number of the transformers 240 and the inverters 230 can be reduced, unlike FIG. 4.

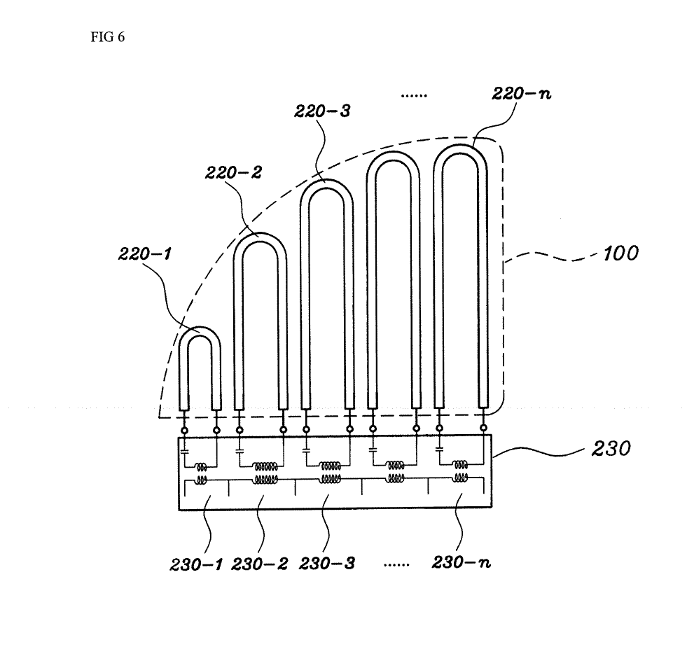

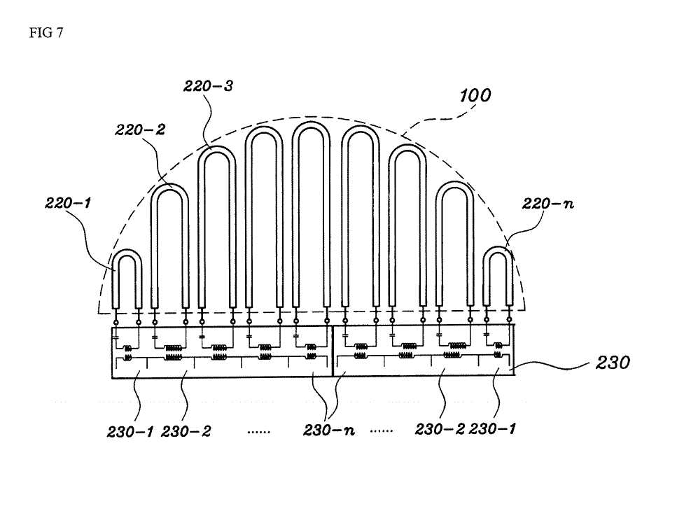

Meanwhile, one inverter 230 can output different voltages to the light sources 220 as shown in FIGS. 6 to 7. In this case, transformers 240 having different resistance are sequentially arranged in the inverter 230.

For example, when the number of the light sources 220 (having the same size) is n, the same number n of transformers 240 are connected to the light sources 220, in which each transformer 240 is connected to the corresponding light source 220.

As shown, the first transformer 240-1 is connected to the first light source 220-1 having the shortest length.

The second transformer 240-2 is connected to the second light source 220-2 that is relatively longer than the first light source 220-1, and the n-th transformer 240-n is connected to the light source 220-n having the greatest length among the light sources 220 in the back light unit 200.

The first transformer 240-1 to the n-th transformer 240-n supply sequentially increasing boosted voltages to the first light source 220-1 to the n-th light source 220-n so that the smallest boosted voltage is supplied to the first light source 220-1 and the greatest boosted voltage is supplied to the n-th light source 220-n. Accordingly, the same image quality can be implemented on the TFT-LCD panel 100 by the light sources 220, 220-1, 220-2 . . . 220-n.

According to the present invention, the transformer and the inverter for controlling the straight light source, particularly, the light sources having a different length, for a back light unit suitable for a TFT-LCD panel having a variety of shapes including circular, elliptical, semicircular, and fan shapes, unlike for a typical TFT-LCD panel having a rectangular shape, are provided to make luminance uniform. Thus, an image of uniform luminance can be displayed on an entire display area of the TFT-LCD panel having a variety of shapes. The present invention may be applied to various display devices having several shapes, such as a monitor for a computer, a game machine, and a liquid crystal for a portable phone.

With the straight light sources having a different length for a back light unit suitable for a liquid crystal display panel having a variety of shapes including circular, elliptical, fan, and semicircular shapes according to the present invention, image quality of uniform luminance can be implemented on the entire display area of the panel.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A liquid crystal display having an inverter for controlling a back light for a liquid crystal display panel having a variety of shapes to obtain uniform luminance, the liquid crystal display comprising:
a TFT-LCD panel having any one of a variety of shapes including a circular shape, an elliptical shape, a circular arc shape, and a shape with an angle other than 90°;
a plurality of straight light sources disposed at a rear side of the TFT-LCD panel and having a different length dependent on the shape of the TFT-LCD panel; and
an inverter and a transformer connected to one terminal of each light source, wherein the inverter induces a same current to the light sources having a different length and the transformer supplies a boosted voltage dependent on the length of each light source to the light source so that luminance is uniform.

2. The liquid crystal display according to claim 1, wherein each light source comprises a U-figured lamp.

3. The liquid crystal display according to claim 1, wherein the light sources having the same length among the plurality of light sources are connected to one inverter and one transformer.

4. The liquid crystal display according to claim 1, wherein all the light sources are connected to one inverter and transformers, and the transformers are arranged sequentially in such a manner that a first transformer is connected to the light source having the smallest length and a last transformer is connected to the light source having the greatest length.
